(19) United States
(12) Patent Application Publication
(10) Pub. No.: US 2011/0118638 A1
(43) Pub. Date: May 19, 2011

(54) SKIN MASSAGER

(75) Inventors: Chang Gyu Yoo, Yongin (KR); Ju Ho Kim, Anyang (KR); Taek Keun Hong, Seoul (KR)

(73) Assignee: AMOREPACIFIC CORPORATION, Seoul (KR)

(21) Appl. No.: 13/001,622

(22) PCT Filed: Jun. 25, 2009
(86) PCT No.: PCT/KR2009/003422

§ 371 Date: Dec. 27, 2010

(30) Foreign Application Priority Data
Jun. 30, 2008 (KR) 20-2008-0008738

(51) Int. Cl. A61H 23/00

(52) U.S. Cl. 601/108

(57) ABSTRACT

Disclosed is a skin massage device, the proposed idea capable of a skin massage device of scrubbing a skin applied with a massage cream, then giving physical stimulus on the skin at a massage thus helping the relaxation of muscles and activating matabolism to serve an elastic, healty skin, characterized in that an operation device 15 to recipocally translate a beating member 21 back and forth is installed at a rotating shaft 14 of a drive motor 15 to which an electric energy of a battery 100 is selectively supplied/blocked according to change of on/off of a rotary switch 12, compised of the beating member 21 inflicting physical stimulus while interworking with the operation device 15.

### CROSS-REFERENCE TO RELATED APPLICATIONS

This application claims priority from Korean Utility Model Application No. 20-2008-0008378, filed on Jun. 30, 2008 in the Korean Intellectual Property Office, the entire disclosure of which is incorporated herein by reference.

### TECHNICAL FIELD

The device relates to a skin massage apparatus capable of scrubbing a skin applied with a massage cream, then giving physical stimulus on the skin at a massage thus helping the relaxation of muscles and activating metabolism to serve an elastic healthy skin, and more particularly to a device delved to translating a rotating motion of a drive motor to a linear motion, beating a skin with a massage plate containing a finger-pressure projection to give physical stimulus to the skin, and thus helping the relaxation of muscles and activating metabolism to maintain an elastic healthy skin.

### RELATED ART

In general, a skin, exposed to ultraviolet, gets thicker in horny substance, so that the skin loses its transparency, the metabolism of skin lowers and as well as fails to smoothly provide moisture and a nutriment.

As a prohibiting means to an aging promotion of skin seniled caused by the above facts, a skin care through massage is eventually used.

A skin care may be divided into two methods of one, in massage, applying a functional cosmetic on skin, and the other method giving physical stimulus to skin in a skin massage.

Of the above methods, in preventing of an ageing promotion of skin by applying a functional cosmetic and thus maintaining moisture of the skin, a moisture preservation is one of none to the second factors in keeping an elastic skin, in which if the moisture maintaining function lowers, the skin has a wrinkle due to the crumbling and no elasticity, also stretchiness.

Thus, by a functional cosmetic applied to skin, a nutriment is furnished, and as well as an applied moisture-keeping cream maintains a moisture thereof

As described above, in a skin massage of applying a functional cosmetic on skin, mainly fingers are used, in which a massage is performed scrubbing the skin by fingers, any physical stimulus to the skin would not occur, thus only expected of a massage effect by functional cosmetics.

Therefore, other than scrubbing a skin applied a functional cosmetic with fingers, by using a skin massage apparatus giving physical stimulus on the skin at a massage thus helping the relaxation of muscles and activating metabolism to serve an elastic, healthy skin, the effect can be doubled.

Continuingly, an existing skin massage apparatus constructed to give physical stimulus to the skin may be chiefly divided into a manual type and an electromotive type.

Of skin massage apparatuses divided as described above, an electromotive type skin massage apparatus that is up to date conveniently used and not laboring is widely used.

The electromotive type skin massage apparatus is constructed to beat skin by a back/forth round trip translation of a massage device with a motor as motive power.

As mentioned above, by beating the skin with a conventional massage device, an advanced massage effect is obtained over when a massage of finger rubbing is conducted to give stimulus up to a dermal layer and a hypodermal tissue composing skin, however, since a translation movement form advance to backing is performed by motive power of the motor in which a massage device of the massage apparatus is directly linked to a drive motor, in a case an overloading occurs due to the massage device overly attached to skin in a massage, the overload directly inflicts the drive motor, having a frequent fault of the motor, such a motor fault connects to a malfunction of the massage apparatus, becoming a factor of imbuing consumers with a negative recognition on products, thus making it difficult to ensure a market competition.

### SUMMARY OF THE INVENTION

### Problem to be Solved

The device has been made to solve disadvantages of a prior-art massage apparatus, an object of the device is to provide a skin massage apparatus in which a beating member of a massage apparatus delved to giving physical stimulus on the skin at a massage thus helping the relaxation of muscles and activating metabolism to serve an elastic, healthy skin when scrubbing a skin above applied with a massage cream in a massage is reformed to minimize an overload produced at a drive motor, thereby advantageously in effect addressing customer's disbelief, a problem caused by a fault of the drive motor, and ensuring reliability of a massage apparatus, thus promoting a massage apparatus use at home and thus solving a burden in taking care of skin searching an expertise beauty shop for accepting a massage and at the same time lessening economical burden accompanying with reducing a use time of expertise beauty shops, and also a skin care employing a break time is possible with no additional time investment, satisfying needs of the consumers.

### Solution for the Problem

To achieve the above object, the present device has been proposed with a skin massage device of scrubbing a skin applied with a massage cream, then giving physical stimulus on the skin at a massage thus helping the relaxation of muscles and activating metabolism to serve an elastic, healthy skin, [15] characterized in that an operation device 15 to reciprocally translate a beating member 21 back and forth is installed at a rotating shaft 14 of a drive motor 13 to which an electric energy of a battery 100 is selectively supplied/blocked according to change of on/off of a rotary switch 12, comprised of the beating member 21 inflicting physical stimulus while interworking with the operation device 15.

### Effect of the Invention

As described above, a skin massage apparatus of the present device has an expedient effect of reforming a beating member of a massage apparatus delved to giving physical stimulus on the skin at a massage thus helping the relaxation of muscles and activating metabolism to serve an elastic, healthy skin when scrubbing a skin above applied with a massage cream in a massage to minimize an overload produced at a drive motor, thereby addressing customer's disbelief, a problem caused by a fault of the drive motor, and ensuring reliability of a massage apparatus, thus promoting a massage apparatus use at home and thus solving a burden in taking care of skin searching an expertise beauty shop for accepting a massage and advantageously at the same time lessening economical burden accompanying with reducing a use time of expertise beauty shops, and also a skin care employing a break time is possible with no additional time investment, satisfying cravings of the consumers.

### BRIEF DESCRIPTION OF THE ACCOMPANYING DRAWINGS

FIG. 1 is a cross-section construction of one embodiment of a skin massage apparatus according to the present device;

FIG. 2 is an exemplary diagram showing that in FIG. 1 state, an operating device operates and thus a beating member acts;

FIG. 3 is a cross-section construction of another embodiment of a skin massage apparatus according to the present device;

FIG. 4 is an exemplary diagram showing that in FIG. 3 state, an operating device operates and thus a beating member acts;

FIG. 5 is a cross-section construction of still another embodiment of a skin massage apparatus according to the present device;

FIG. 6 is an exemplary diagram showing that in FIG. 5 state, an operating device operates and thus a beating member acts;

FIG. 7 is a cross-section construction of still another embodiment of a skin massage apparatus according to the present device;

FIG. 8 is an exemplary diagram showing that in FIG. 7 state, an operating device operates and thus a beating member acts;

FIG. 9 is a cross-section construction of still another embodiment of a skin massage apparatus according to the present device; and

FIG. 10 is an exemplary diagram showing that in FIG. 9 state, an operating device operates and thus a beating member acts.

### <DESCRIPTION OF THE ACCOMPANYING DRAWINGS>

10: the first case 11: the battery receiving part

12: a rotary switch 13: the drive motor

14: the rotating shaft 15: the operating device

16: the main power member 16a: a connection part

16b, 17b ; a circular plate cam 16c, 17c: a slanted surface

16d: a main power bevel gear 16e: the empowered bevel gear

16f: a cam 16g: a spiral-type groove

16h: a guide pipe 16h′: the vertical guide hole

17: the empowered member 17a: a connection pipe

17d: a guide protrusion 20: the second case

21: the beating member 21a: the head mounting circular plate

22: a beating head 22a: stimulus protrusions

### DETAILED DESCRIPTION

Hereinafter, a preferred embodiment of the present device will be described in more detail with reference to the accompanied drawings to the specification.

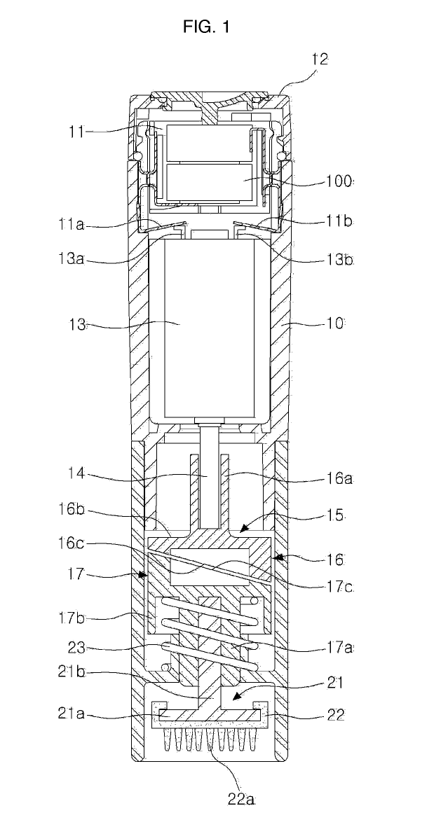

As illustrated in FIGS. 1 and 10, a skin massage apparatus of the device is composed of a connection of a first case 10 installed with a battery receiving part 11 receiving a battery 100 and an operation device 15 equipped with a drive motor 13 and operated by the drive motor 13; and a second case equipped with a beating member 21 interworking with the operation device 15.

The battery receiving part 11 of the first case 10 is installed with +, −ground plates 11a, 11b grounded at +electrode and −electrode of the received battery 100 supplying electric energy of the battery 100 to the drive motor 13, and a rotary switch 12 for selectively supplying electric energy of the battery 100 is installed.

A drive motor 12 in which +,−ground terminals 13a, 13b are grounded for the +,−ground plates 11a, 11b is installed in the neighborhood.

The opposite side of the battery receiving part 11 is installed with an operating device 15 operating by the drive motor 13.

The operating device 15 is comprised of a main power member 16 connected to the rotating shaft 14 of the drive motor 13 and an empowered member 17 interworking with the main power member 16.

The empowered member 17 is installed inside the second case 20 to receive a repulse elastic force of a spring 18, and the empowered member 17 is installed with a beating member 21.

The main power member 16 is key assembled to the rotating shaft 14 of the drive motor 13 using a connection part 16a as a medium, made of a circular plate cam 16b formd with a slanted surface 16c, its one side low and the other side high, and the empowered member 17 has a slanted surface 17c corresponding to the circular plate cam 16b slanted surface of the main power member 16 and at the same time has a circular plate cam 17b contacting in plane facing each other, and a lower part of the circular plate cam 17b is formed with a connection pipe 17a connected of a connection pole 21b formed towards the upper part of a head mounting circular plate 21a of the beating member 21.

The connection pipe 17a of the circular plate cam 17b is a repulse spring 23 inflicting an elastic repulse force to outside for enabling a round-trip movement.

The beating member 21 installed at the empowered member 17 of the operating device 15 placed inside the second case 20, has a connection pole 21b inserted at installation to the connection pipe 17a of the empowered member 17. and the head mounting circular plate 21 a formed to an end part of the connection pole 21b is assembled molded with a beating head 22 irregularly arranged of a multiple of stimulus protrusions 22a. [50] The beating head 22 is injection-molded by rubber material.

A main power member 16 of another embodiment of the operating device 15 is comprised of a main power bevel gear 16d installed at the drive motor 13, an empowered bevel gear 16e interworking engaged with the main power bevel gear 16d, and a cam 16f installed on the same axis for interworking with the empowered bevel gear 16e, and an empowered member 17 moving back/forth close to a cam 16f of the main power member 16 and formed with a connection pipe 17a engaged to the connection pole 21b of the beating member 21. and installed to receive repulse of the repulsing spring 23 for restoring after advancement.

A main power member 16 of still another embodiment of the operation device 15 is comprised of a main power bevel gear 164 installed at the drive motor 13, an empowered bevel gear 16e interworking engaged to the main power bevel gear 16d and a cam 16f installed on the same axis for interworking the empowered bevel gear 16e, and made of a crank rod 18, one end hinge-connected to the cam 16f of the main power member 16, and the other end hinge-connected to a connection pole 21b of the beating member 21.

In an installment of a main power member 17 of still another embodiment of the operating device 15, a connection part 16a is key assembled to the drive motor 13, a spiral-type groove 16g guided for a guide protrusion 17d of the empowered member 17 is formed to an inner-rim surface, and a guide pipe 16h having a vertical guide hole 16W is placed to the inner side to be fixed to the second case 20 so that the empowered member 17 round-trip moves back/forth without circulation.

In the empowered member 17 interworking by the main power member 16, the guide protrusion 17d passing through the vertical guide hole 16W of the guide pipe 16h, and in which the end part is placed at the spiral-type groove 16g of the main power member 16 is formed to face an outer-rim surface, and a connection pipe 17a connecting to the connection pole 21b of the beating member 21 is formed.

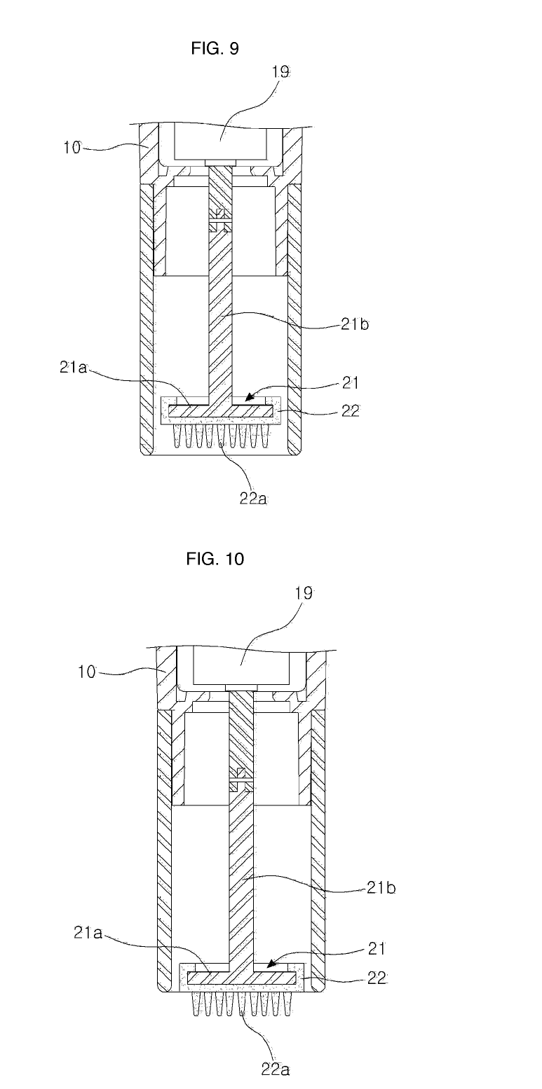

FIGS. 9 and 10 are another embodiment of the present device, possibly constructed that a connection pole 21b of the beating member 21 moves back/forth directly connected to a piston rod of a solenoid 19.

In a case of performing a massage on skin using a skin massage apparatus of the present device comprised of the above-described construction, first applying a massage cream on the part for a massage to moisturize the skin and then beating all around can create a doubled effect.

When beating and massaging skin with a skin massage apparatus of the present device, the rotary switch 12 rotationally operates to place from off state to on state.

As described above, when the rotary switch 12 transits from off state to on state, electric energy of a battery 100 mounted at the battery receiving part 11 is supplied to the drive motor 13.

As such, the drive motor 13 supplied with electric energy drives, and rotational power produced by the drive of the drive motor 13 is delivered to the main power member 16 of the operating device 15 connected to the rotating shaft 14 to interwork with the empowered member 17, so that the main power member 16 interworks with the empowered member 17 and a beating member 21 installed at the empowered member 17 round-trip moves back/forth.

As above, when the beating member reciprocally moves back/forth, the stimulus protrusion 22a of the beating head constructing the beating member fully inflicts physical stimulus to skin, capable of helping relaxation of muscles and activating metabolism and thus serving an elastic, healthy skin.

In the following, an operation state of the operating device 15 allowing a massage of skin by reciprocally moving the beating member 21 will be described for each embodiment.

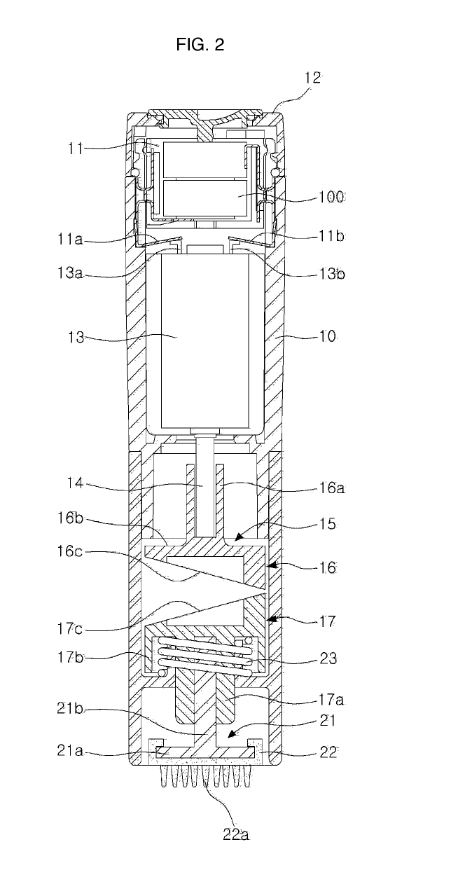

Referring to the operating device 15 exemplified in FIGS. 1 and 2, when the rotary switch 12 described above converts from off to on state and the drive motor 13 rotationally operates by electric energy of the battery 100, the slanted surface 16c of the main power member 16 contacting in surface over the slanted surface 17c of the empowered member 17 like FIG. 1 continuously repeats a procedure placed like FIG. 2, and thus the beating member 21 installed at the empowered member 17 advances, and by repulsive power of the repulse spring 23 compressed by advance of the beating member 21, the empowered member moves backward and thereby the beating member 21 everlastingly round-trip moves.

As mentioned above, as the beating member 21 round-trip moves, a stimulus protrusion 22a of the beating head 22 constructing the beating member gives physical stimulus on skin, helping maintain a healthy skin recited at the upper part.

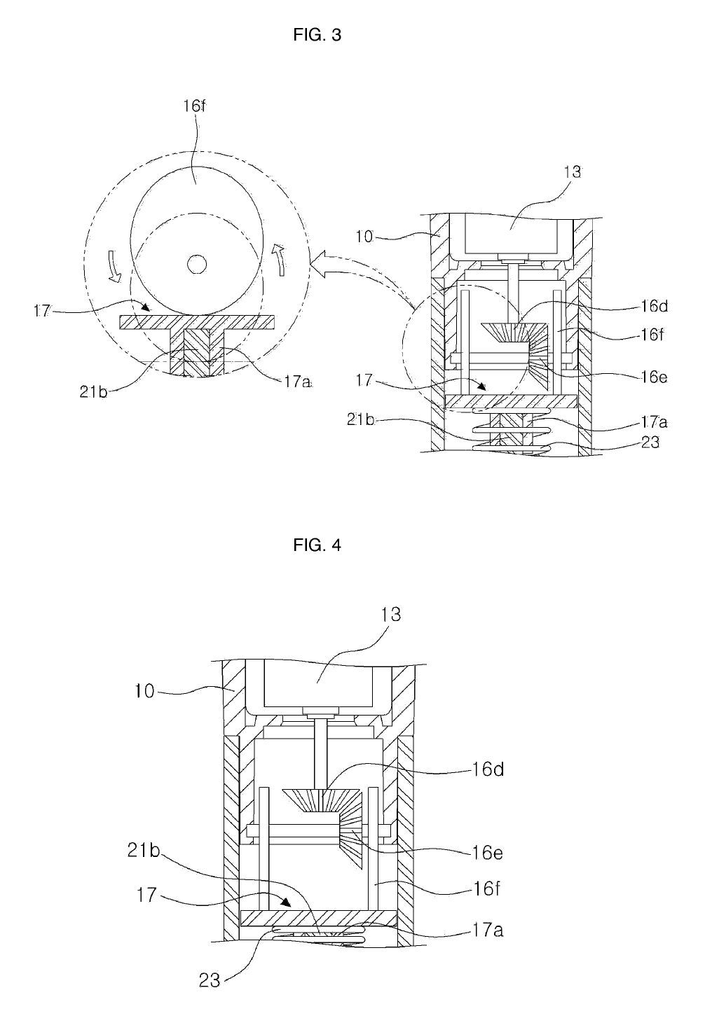

FIGS. 3 and 4 are an embodiment of another operation device, when a rotary switch 12 converts from off to on state to rotationally operate the drive motor 13 by electric energy of the battery 100, a main power bevel gear 16d constructing the main power member 16 inter-operates, the empowered bevel gear 16e engaged to the interworking main power bevel gear 16d as described above operates together.

As explained above, when the empowered bevel gear 16e is interworking, the cam 16f installed on the same axis of the empowered bevel gear 16e operates together and thus the cam 16f stayed in a FIG. 3 state positions as shown in FIG. 4 to move the empowered member 17.

Described above, as the empowered member 17 moves, the beating member 21 installed at the connection pipe 17a using the connection pole 21b as a medium advances, and by means of repulse power of the repulse spring 23 compressed by the advance of the beating member 21, the empowered member 17 moves back so that the beating member 21 continuously round-trip moves.

Explained above, as the beating member 21 moves round-trip, a stimulus protrusion 22a of the beating head 22 constructing the beating member 21 gives physical stimulus to skin thereby to maintain a healthy skin as mentioned above.

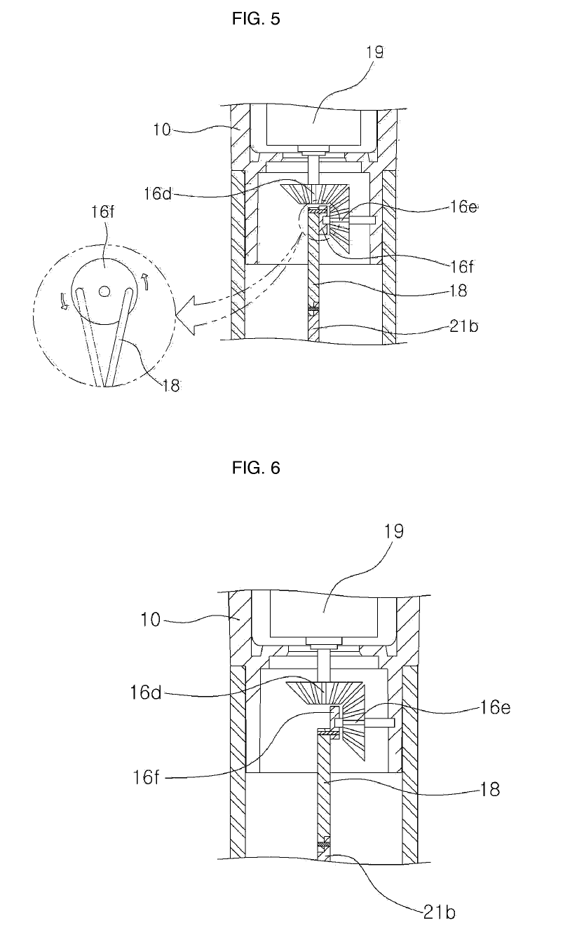

FIGS. 5 and 6 are other embodiments of an operating device, when a rotary switch 12 converts from off to on state to rotationally operate the drive motor 13 by electric energy of the battery 100, a main power bevel gear 16d constructing the main power member 16 inter-operates, the empowered bevel gear 16e engaged to the interworking main power bevel gear 16d as described above operates together.

As described above, when the empowered bevel gear 16e is interworking, the cam 16f installed on the same axis of the empowered bevel gear 16e operates together and thus the cam 16f stayed in a FIG. 5 state positions as shown in FIG. 6 to move a crank rod 18 corresponding to the empowered member.

As such, one end of a crank rod 18 interworking by the cam 16f hinge-connects to the cam 16f, and the other end hinge-connects to the connection pole 21b of the beating member 21 so that the beating member 21 continuously round-trip moves.

Explained above, as the beating member 21 moves round-trip, a stimulus protrusion 22a of the beating head 22 constructing the beating member 21 gives physical stimulus to skin thereby to maintain a healty skin as mentioned above.

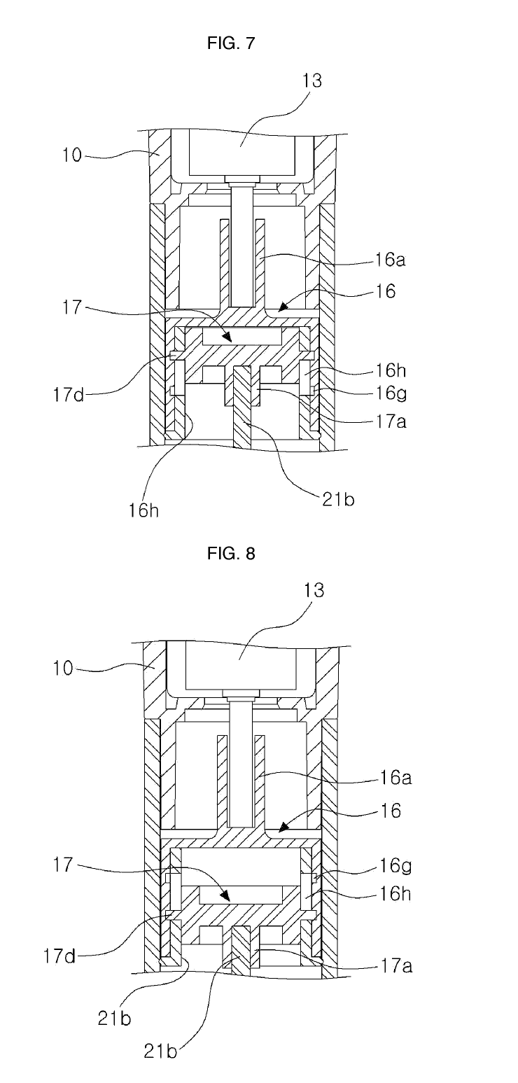

FIGS. 7 and 8 are other embodiments of an operating device, when a rotary switch 12 converts from off to on state to rotationally operate the drive motor 13 by electric energy of the battery 100, a guide protrusion 17d of the empowered member 17 placed at the upper part of the spiral-type groove 16g of the main power member 16 like FIG. 7 is positioned under the spiral-type groove 16g like FIG. 8, so that the beating member 21 installed with the connection pole 21b connected to the connection pipe 17a advances forward.

At this time, moving forward of the empowered member 17 without rotation is because to a vertical guide hole 16W of the guide pipe 16h fixed to the second case 20 is guide protrusion 17d guided.

As such, in an advanced state, the drive motor 13 drives in a backward direction, so that the beating member 21 continuously round-trip moves.

Explained above, as the beating member 21 moves round-trip, a stimulus protrusion 22a of the beating head 22 constructing the beating member 21 gives physical stimulus to skin thereby to maintain a healthy skin as mentioned above.

FIGS. 9 and 10 are other embodiments of the present device, with intention that a back/forth round-trip movement of the beating member 21 is performed by the solenoid 19, a connection pole 21b of the beating member 21 is directly related to the piston rod of the solenoid 19.

While the solenoid 19 connected to the beating member 21 round-trip moves back/forth by a piston rod stroke distance, the stimulus protrusion 22a of the beating head 22 imbues physical stimulus to skin thereby to maintain a healthy skin as mentioned above.

What is claimed is:

1. A massage device of giving physical stimulus on the skin at a massage thus helping the relaxation of muscles and activating matabolism to serve an elastic, healty skin, characterized in that
an operation device 15 to recipocally translate a beating member 21 back and forth is installed at a rotating shaft 14 of a drive motor 13 to which an electric energy of a battery 100 is selectively supplied/blocked according to change of on/off of a rotary switch 12, and comprised of the beating member 21 inflicting physical stimulus while interworking with the operation device 15.

2. The device of claim 1, wherein the operating device 15 comprise:
a main power member 16 assembled to the rotating shaft 14 of the drive motor 13 using a connection part 16a as a medium, made of a circular plate cam 16b formd with a slanted surface 16c, its one side low and the other side high; and
an empowered member 17 having a slanted surface 17c corresponding to the circular plate cam 16b slanted surface of the main power member 16 and at the same time having a circular plate cam 17b contacting in plane facing each other,
wherein a lower part of the circular plate cam 17b is formed with a connection pipe 17a connected of a connection pole 21b formed towards the upper part of a head mounting circular plate 21a of the beating member 21, and elastic-supported by a repulse spring 23 placed toward outside of the connection pipe 17a.

3. The device of claim 1, wherein the operating device 15 includes:
a main power member 16 comprised of a main power bevel gear 16d installed at the rotating shaft 14 of the drive motor 13, an empowered bevel gear 16e interworking engaged with the main power bevel gear 16d, and a cam 16f installed on the same axis for interworking with the empowered bevel gear 16e; and
an empowered member 17 moving back/forth close to a cam 16f of the main power member 16 and formed with a connection pipe 17a engaged to the connection pole 21b of the beating member 21. and installed to receive repulse of the repulsing spring 23 for restoring after advancement.

4. The device of claim 1, wherein the operating device 15 includes:
a main power member 16 comprised of a main power bevel gear 164 installed at the rotating shaft 14 of the drive motor 13, an empowered bevel gear 16e interworking engaged to the main power bevel gear 16d and a cam 16f installed on the same axis for interworking the empowered bevel gear 16e; and
a crank rod 18, one end hinge-connected to the cam 16f of the main power member 16, and the other end hinge-connected to a connection pole 21b of the beating member 21.

5. The device of claim 1, wherein the operating device 15 includes:
a main power member 16 in which a connection part 16a is assembled to the rotating shaft 14 of the drive motor 13, a spiral-type groove 16g guided for a guide protrusion 17d of the empowered member 17 is formed to an inner-rim surface, and a guide pipe 16h having a vertical guide hole 16W is placed to the inner side and simultaneously fixed to the second case 20 so that the empowered member 17 round-trip moves back/forth without circulation; and
an empowered member 17 in which the guide protrusion 17d passing through the vertical guide hole 16W of the guide pipe 16h of the main power member 16, its the end part is placed at the spiral-type groove 16g of the main power member 16, is formed to face an outer-rim surface, and a connection pipe 17a connecting to the connection pole 2 lb of the beating member 21 is formed.

6. The device of claim 1, wherein the beating member 21 moves back/forth by a solenoid 19.

7. The device of claim 1 or 6, wherein the beating member 21 has a connection pole 21b inserted at installation to the connection pipe 17a of the empowered member 17. and formed of assembling of a beating head 22 that a head mounting circular plate 21a formed to an end part of the connection pole 21b is irregularly arranged of a multiple of stimulus protrusions 22a.
